(19) United States
(12) Patent Application Publication
(10) Pub. No.: US 2009/0201201 A1
(43) Pub. Date: Aug. 13, 2009

(54) Interactive multimode tracking system and method

(76) Inventor: Mark Gerald Foster, Avila Beach, CA (US)

Correspondence Address: Mark G. Foster, P.O. Box 669, Avila Beach, CA, 93424, US

(21) Appl. No.: 12/321,273

(22) Filed: Jan. 20, 2009

Related U.S. Application Data
(60) Provisional application No. 61/062,048, filed on Jan. 22, 2008.
(60) Provisional application No. 61/011,964, filed on Jan. 22, 2008.
(60) Provisional application No. 61/062,006, filed on Jan. 22, 2008.

(51) Int. Cl. G01S 1/00

(52) U.S. Cl. 342/357.07

(57) ABSTRACT

An interactive multimode tracking system and method is disclosed. In general, the tracking system comprises a central office that interactively communicates with various portable tracking units over at least two communication networks. The multiple communication networks help maintain a connection with the tracking units. The central office can also actively manage the information provided a user of the tracking unit. This allows the central office to change the route of the user based on changing conditions.

### CROSS REFERENCE TO RELATED APPLICATIONS

This application claims priority under 35 U.S.C. 119(e) to: U.S. Provisional Patent Application No. 61/062,048, entitled Interactive Multimode Tracking System and Method, having a priority filing date of Jan. 22, 2008, and is related to U.S. Provisional Patent Application No. 61/011,964, entitled Multimode Tracking Unit and Method, having a priority filing date of Jan. 22, 2008, and U.S. Provisional Patent Application No. 61/062,006, entitled Central Office Management of Interactive Tracking Units, having a priority filing date of Jan. 22, 2008.

### FIELD OF THE INVENTION

This invention generally relates to global positioning tracking systems and more specifically to an interactive multimode tracking system and method.

### BACKGROUND OF THE INVENTION

Navigation units, such as the Global Positioning System (GPS), have revolutionized both personal and business navigation. Cars have navigation units that allow the driver to enter a destination and the navigation unit will plot a map a route to the destination, even providing driving instructions on where to turn. Airplanes have navigation units that allow the pilots to plot a direct route from airport to airport. Mobile phones also include a navigation functionality that allows a user to finding where they are, where they may want to go and can give emergency services the exact location of the user in case of an emergency.

Conventional navigation units typically triangulate their position from an outside reference, such as a series of satellites, and then overlays that position on a set of maps stored within the navigation unit. Map addresses and specific destinations, such as restaurants, hotels, airports and other areas of interest, are also stored within the navigation unit. This allows the user to input an address or other destination and the navigation unit will plot a route from its current location to the selected destination.

Some navigation units allow the user to speak directly to a central operator over a cell phone network. The central operator receives the position of the user and can provide assistance, such as calling emergency services, unlocking the vehicle doors and verbally giving the user directions. Although these systems provide some interaction with the user, they are limited by how they communicate with the user and don't allow for centralized management of the navigation data displayed to the user.

### SUMMARY OF THE INVENTION

The present invention provides an interactive multimode tracking system embodiment of the present invention, a tracking system comprises a central office operable to communicate with a plurality of tracking units over at least two communication networks. At least one tracking unit includes a display, a locator operable to determine the position of the tracking unit and a multimode communication system that operates to communicate with the communication networks. The tracking units operate to report its position to the central office and the central office sends navigation data to the tracking unit. The navigation data is generally a route to a specific destination, but may include other information, such as a destination address, weather, query results or other suitable information.

At least one embodiment of this invention has the advantage of having redundant communication networks. This allows the central office to maintain contact with the tracking unit even when one form of communication is lost. For example, in the preferred embodiment, the communication networks comprise a cellular communication network as the primary network and a satellite communication network as a secondary network. When the tracking unit is out of range of the cellular communication network, the tracking unit can generally communicate over the satellite communication network.

At least one embodiment of this invention also has the advantage of actively managing the navigation data provided to the tracking unit. This allows the route or destination to be changed by the central office without input from the user.

Other advantages will be readily apparent to one skilled in the art from the following figures, descriptions, and claims.

### BRIEF DESCRIPTION OF THE DRAWINGS

For a more complete understanding of the invention and the advantages thereof, reference is now made to the following description taken in conjunction with the accompanying drawings, wherein like reference numerals represent like parts, in which:

FIG. 1 is a schematic diagram of a tracking system in accordance with one embodiment of the present invention,

FIG. 2 is a schematic diagram of a tracking unit in accordance with one embodiment of the present invention;

FIGS. 3A-3F illustrate different types of navigation data that can be displayed to the user on the tracking unit; and

FIG. 4 is a schematic diagram of a central office in accordance with one embodiment of the present invention.

### DETAILED DESCRIPTION OF THE PREFERRED EMBODIMENTS

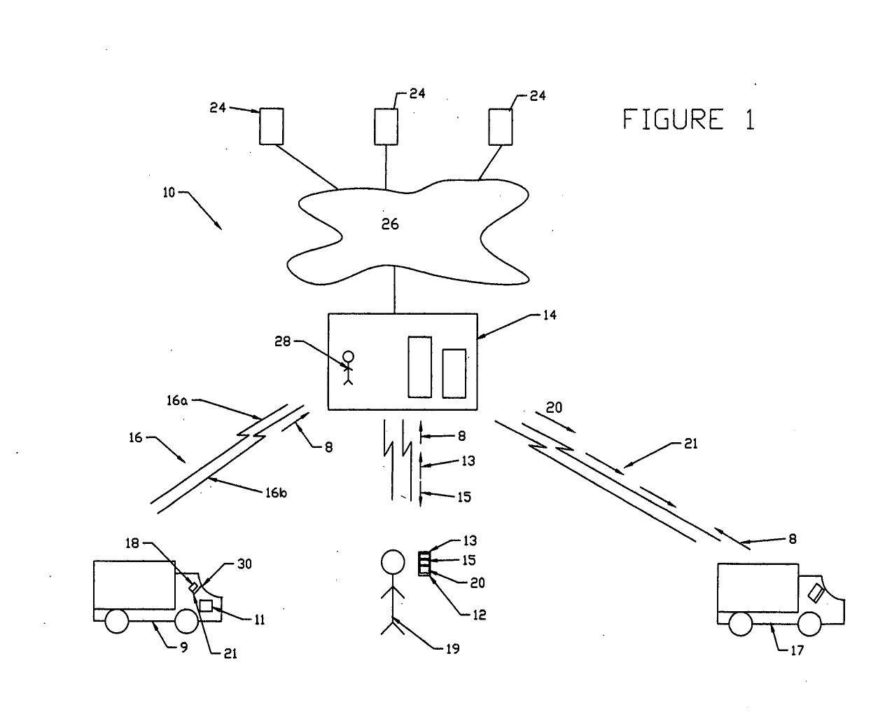

FIGS. 1 through 4 illustrate one embodiment of an interactive multimode tracking system in accordance with the present invention. The invention is generally described in terms of using the invention in a vehicle, but the scope of this invention should not be limited to this embodiment. The teachings of this invention can be applied to an interactive multimode tracking system for individuals, varying types of vehicles, or devices, such as individual consumers, airplanes, service and emergency vehicles, service and military personnel, packages, suitcases and such other objects to be tracked.

The invention is described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

FIG. 1 illustrates one embodiment of a tracking system 10 in accordance with one embodiment of the present invention In this embodiment, the tracking system 10 comprises a plurality of tracking units 12 operable to communicate with at least one central office 14 through at least two communication networks 16a, 16b to 16n. Each tracking unit 12 communicates tracking data 18 to the central office 14 and the central office 14 communicates navigation data 20 to the tracking unit 12.

The tracking units 12 are portable units that can use any suitable technology to determine its position. In the preferred embodiment, the tracking units 12 utilize the Global Satellite System of satellites to determine its position. In other embodiments, the tracking units 12 can use cellular triangulation or radio triangulation to determine its position. The tracking unit 12 operates to determine its position and preferably report its position frequently to the central office 14. The tracking unit 12 also operates to receive and display the navigation data 20 to the user. In many applications, the tracking unit 12 includes a mounting bracket 21 that attaches the tracking unit 12 to a vehicle, such as a car, truck, airplane or other suitable vehicle. In addition to providing a mounting point, the mounting bracket 21 can provide power and tie the tracking unit 12 into the vehicles systems.

The central office 14 provides centralized control and management of the navigation data 20 provided to the tracking unit 12, which typically controls the route and destination of the user. In the preferred embodiment, the central office 14 includes network connection 25 that allows third party entities 24 to access the central office 14 over an external network 26. In the preferred embodiment, the external network 26 is the World Wide Web and the entities 24 login to the central office 14 through a secure connection, such as a VPN connection. Each entity 24 can directly control and manage the navigation data 20 delivered to each of the tracking units 12 associated with that entity 24. It also allows the central office 14 to simultaneously be used for different purposes, as describe in greater detail below. The central office 14 preferably includes one or more operators 28, but may comprise an automated system or a combination of manned and automated.

The communication networks 16 can use any suitable communication technology for communicating the tracking data 18 and navigation data 20 between the tracking units 12 and the central office 14. In the preferred embodiment, the communication networks 16 comprise a cellular communication system and a satellite communication system. In other embodiments, the communication network 16 may include a radio communication system. The multiple communication networks 16 provide redundancy to help prevent the loss of contact between the central office 14 and the tracking units 12. For example, cellular systems are inexpensive to use, but have dead zones, and satellite systems are expensive to use, but generally have better coverage. Together they provide complete coverage at a reasonable cost.

In operation, the tracking system 10 can be used in multiple implementations. The tracking data 18 and navigation data 20 generally varies based on the implementation of the tracking system 10. In a tracking system 10a used for fleet services 9, such as emergency and utility services, the tracking 18 typically comprises the position of the navigation unit 12 and the navigation data 20 typically includes the map, address and information on the specific type of emergency. The tracking data 18 can also include vehicle data 11, such as the equipment available on the vehicle, so that the central office 14 can coordinate vehicles to have the required equipment at the particular location. In a tracking system 10b used for individual consumers 19, the tracking data 18 typically comprises the position 8 of the tracking unit 12 and the navigation data 20 typically comprises a map showing the position of the individual. The navigation data 20 may also show on the map the relevant businesses near the individual. In this consumer implementation, the tracking unit 12 is embodied in any suitable system, such as a stand-alone device or incorporated into a cell phone. In a tracking system 10c used to manage a pickup/delivery service, the tracking data 18 typically comprises the position of the navigation unit 12 and the navigation data 20 typically comprises a map showing the route and destination for the next pickup or delivery of a package 17. The tracking system 10 may also include a cradle 30 for connecting the tracking unit 12 to a vehicle.

An advantage of at least one embodiment of the tracking system 10 is that it can actively manage the navigation data 20. For example, in one embodiment of a tracking system 10 used for a package delivery service, the entity 24 can accelerate package 17 pickup by re-routing the closest vehicle by updated the navigation data 20 provided to that vehicle with the new route and destination. The driver only needs to follow the map. The tracking system 10 used for emergency services, such as ambulance, fire, police and utility services, can often accelerate the deployment of emergency services. In one embodiment, the entity 24 can route the closest emergency vehicle to the emergency, as well as route a vehicle with the right equipment for the type of emergency. This helps accelerate the arrival of emergency personnel and the proper equipment to the emergency. In a consumer application of the tracking system 10, the central office 14 can direct the user until they reach their destination.

The tracking system 10 also enables the navigation data 20 to be updated in response to both positive (improved traffic flow) and negative environmental effects, such as traffic patterns, accidents, construction, road closings, restrictions and weather, both positive. For example, in one embodiment the central office 14 monitors traffic patterns. In this embodiment, the central office 12 can update 21 the navigation data 20 based on the traffic patterns to route the user along the most efficient or fastest route and avoid the lease efficient or slowest route. In this embodiment, each entity 24 can also manage the navigation data 20 using algorithms specific to that entity 24. For example, certain entities 24 may want to optimize for speed to the destination, other entities may want to optimize for fuel efficiency and even other entities 24 may want to optimize for safety.

The tracking system 10 may also allow the user to obtain information. In one embodiment, the user enters a query, verbal, text or otherwise, on the tracking unit 12, such as a request about restaurants in the immediate area. The query 13 is sent to the central office 14 as part of the tracking data 18. The central office 14 makes a search based on the query and sends the query results 15 to the tracking unit 12, which in this example would be a list of restaurants. The user can then select a specific query result, i.e, restaurant, which is sent to the central office 14, where a map and route from the current position to the destination is sent to the tracking unit 12 as the navigation data 20. In a further embodiment, the tracking unit 12 enables the user to directly, or indirectly, contact the destination party. For example, once a restaurant is selected, the user could also make reservations at the restaurant.

The tracking system 10 may also provide voice communication services. In one embodiment, the tracking unit 12 includes a speaker and microphone that allows the user to contact the operator 28 in the central office 14 for assistance. The central office 14 can also include a connection to an outside phone network 32 to allow the user to make phone calls through the tracking unit 12.

The tracking system 10 may comprise other suitable devices and systems without departing from the scope and spirit of the present invention. For example, the tracking system 10 may also provide the user additional information from third party sources, such as sports scores, business news, text messages and other such information.

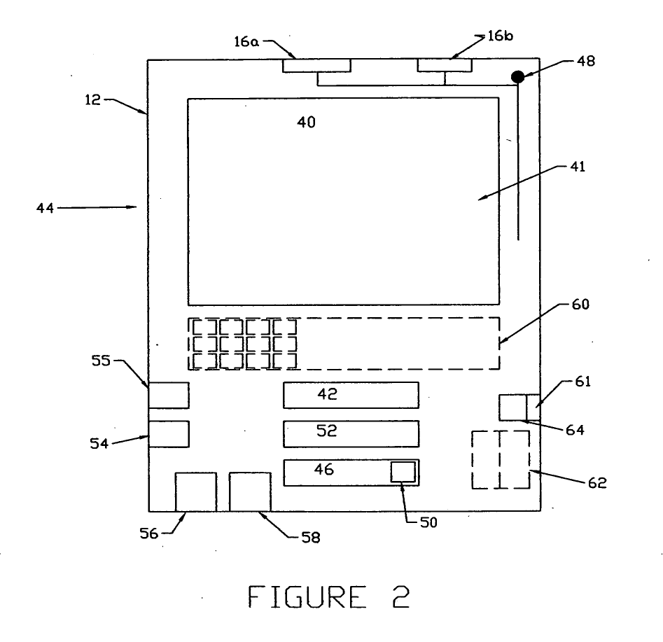

FIG. 2 illustrates the tracking unit 12 in accordance with one embodiment of the present invention. In this embodiment, the tracking unit 12 includes a display 40, a locator 42 and a multimode communication system 44. The tracking unit 12 generally includes a central processing unit 46, although in some embodiments the functionality of the central processing unit 46 is incorporated into the other components of the tracking unit 12.

The display 40 may comprise any suitable device for displaying the navigation data 20 to the user. In the preferred embodiment, the display 40 comprises a LCD touch screen 41. In other embodiments, the display 40 may comprise a standard LCD screen, CRT screen, electronic paper or other suitable form of display.

The locator 42 may comprise any suitable device for determining the location of the tracking unit 12. In the preferred embodiment, the locator 42 comprises a Global Positioning System locator, but may also comprise a cellular locator or radio locator depending on the application.

The multimode communication 44 may comprise any suitable system for send the tracking data 18 to the central office 14 and receive the navigation data 20 from the central office 14 over the communication networks 16a, 16b to 16n. The design of the multimode communication system 44 depends on the communication networks 16 to be used. In the preferred embodiment, the multimode communication system 44 includes both a cellular and satellite receiver/transmitter, with the cellular system being the default and the satellite system activated when the cellular system is unavailable. The multimode communication system 44 may also use radio communication, wireless communication or other suitable forms of communication systems. The multimode communication system 44 may also include an antenna 48 to improve the range of the multimode communication system 44. The antenna 48 can be integral to the tracking unit 12, as illustrated, or can be remotely located on a vehicle, such as a car, truck or airplane.

The central processing unit 46 may comprise any suitable system for managing the functionality of the display 40, locator 42, multimode communication system 44 and other components of the tracking system 12. The central processing unit 46 includes tracking unit software 50 that can be updated remotely from the central office 14 or locally through the port, as described below.

The tracking unit 12 preferably includes memory 52 that can be used to store information, such as local maps, attractions and the like. The information stored on memory 52 can be used for navigation to limit the amount of data and cost of transmitting the navigation data 20 over the communication networks 16. The memory 52 is preferably solid state memory, such as flash memory 55, but may comprise any suitable storage system, both installed and removable.

The tracking unit 12 preferably includes a port 54 for accessing the programming or information stored on the tracking unit 12. In the preferred embodiment, the port 54 comprises a universal serial bus (USB) port, but may comprise an Ethernet port or other suitable connection.

The tracking unit 12 preferably includes a speaker 56. The speaker 56 allows the tracking unit 12 to verbally cue the user on the route, route changes, messages or any other information that would assist the user. The tracking unit 12 also preferably includes a microphone 58 with the speaker 56. The microphone 58 allows the user to give the tracking unit 12 verbal commands, converse with the operator 28, make a call over the phone network 32 or perform any other suitable audible functions.

The tracking unit 12 may also include a keyboard 60 that allows the user to input data into the tracing unit 12. In the preferred embodiment, the keyboard 60 is incorporated into the display 40 as a touch screen display. In another embodiment, the keyboard 60 is separate from the display 40. The keyboard 60 allows the user to respond to the central office 12, enter a phone number to be dialed, type a query, enter a password for the tracking unit 12, enter a destination address, customize the personal preferences or perform any other data input function.

The tracking unit 12 may also include batteries 62 to maintain the operation of the tracking unit 12. The batteries 62 are preferably lithium ion batteries, but may comprise any suitable power system 61, such as replaceable batteries, chemical fuel cells and other such power supplies. In this embodiment, the tracking system 12 preferably includes power saving circuitry 64 to conserve the batteries 62. This allows the tracking unit 12 to be manually switched to a power saving setting or automatically switch to a power saving setting after a designated amount of time of non-use.

The tracking unit 12 may comprise other suitable devices and systems without departing from the scope and spirit of the present invention. For example, the tracking unit 12 may include a radio frequency identification (RFID) system that automatically detects and reports to the central office 12 the position and condition of all packages with an RFID tag in the vehicle. The tracking unit 12 can also be personalized to different users, allowing each user to select the sounds, font and map size shown on the display 40, date, time and other suitable functions.

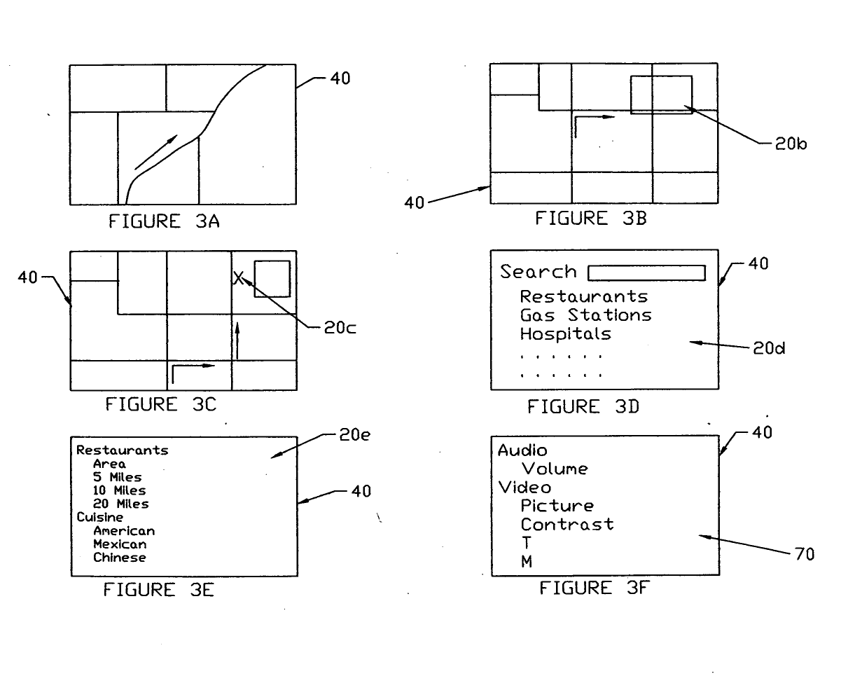

FIGS. 3A-3F illustrate various types of navigation data 20 that can be displayed on the display 40 of the tracking unit 12. In some embodiments, the tracking unit 12 may have maps and other data stored on memory 52. In these embodiments, the navigation data 20 displayed on the display 40 can be data delivered solely from the central office 14 or some combination of the data stored on the tracking unit 12 and data delivered from the central office 14.

FIG. 3A illustrates route navigation data 20a comprising a map showing the immediate driving directions. FIG. 3B illustrates updated navigation data 20b comprising a map with a new route to the destination. FIG. 3C illustrates destination navigation data 20c comprising a map and the address of the desired destination. FIG. 3D illustrates query navigation data 20d comprising a search query screen that allows the user to enter text for searching one or more databases 23 or the Internet For example, the query navigation data 20d allows a user to request information on restaurants based on location, cuisine, atmosphere, ratings, etc. FIG. 3E illustrates query results navigation data 20e comprising the results of the query navigation data 20d. Following the above example, the query results navigation data 20e would comprise a list of restaurants meeting the query criteria. The user can make a selection from the query results navigation data 20e to receive additional information. FIG. 3F illustrates a personalization screen 70 which allows the user to personalize the settings of the tracking unit 12 to suit their individual needs/desires. The navigation data 20 may comprise any suitable information without departing from the spirit and scope of the present invention. For example, the navigation data 20 may include text and audio information.

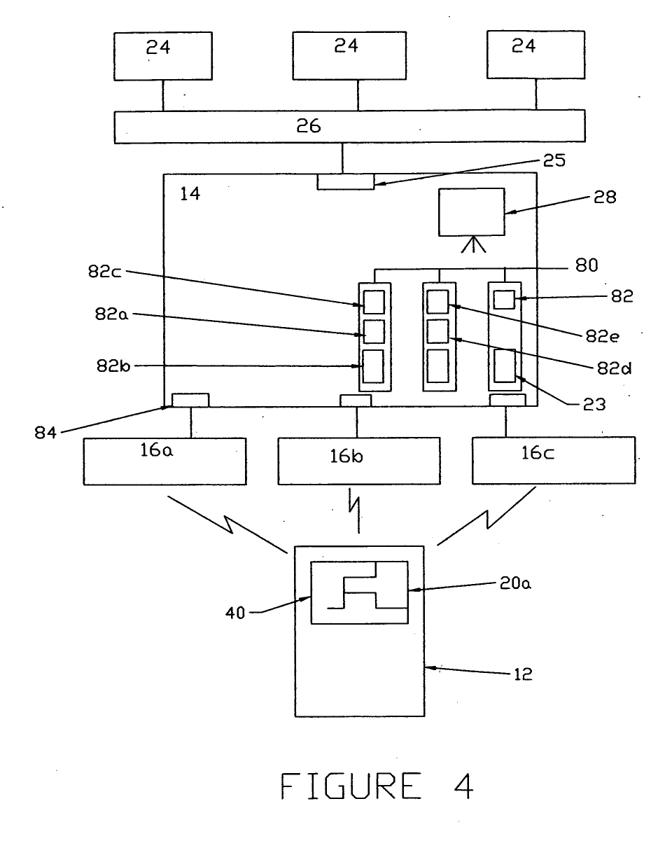

FIG. 4 illustrates a central office 14 in accordance with one embodiment of the present invention. In this embodiment, the central office comprises a computer system 80 with backend applications 82 running on the computer system 80, and a communication network hub 84 that communicates with the communications networks 16.

The computer system 80 may comprise any suitable computer system, i.e., servers, operable to run the backend applications 82. The backend applications 82 may comprise any suitable computer programs operable to provide relevant and helpful navigation data 20 to the user of the tracking unit 12. In the preferred embodiment, the backend applications 82 comprise a map application 82a, a tracking application 82b and a communications application 82c. In this embodiment, the map application 82a operates to plot the route from the current position of the tracking unit 12 to the destination. The map application 82a can also optimize the route with certain algorithms according to specific criteria. For example, the map application 82a can optimize the route to minimize the time to the destination, or the route can be optimized to minimize the travel distance to the destination, or otherwise optimize the route. The route is then sent as navigation data 20 to the tracking unit 12. The tracking application 82b operates to track the tracking unit 12, receiving position data from the tracking unit on a regular basis. The tracking application 82b can include alerts that notify the user or the entity 24 if the user deviates from a planned route or if the tracking unit 12 stops for an extended time. This helps alert someone to a potential problem. The communications application 82c operates in conjunction with the communication network hub 84 to send and receive data to the tracking unit 12. Specifically, the communication network hub 84 comprises a network connection to each of the communication networks 16. The communications application 82c manages the traffic and which communication network 16 to use to communicate with the tracking unit 12. The backend application 82 may also include an environmental application 82d that operates to receive environmental information that may affect the route of the users. The environmental application 82d provides input into the map application 82a to help optimize the route based on current or expected environmental conditions along the route. The backend applications 82 also preferably includes one or more technology applications 82e that provides the programming or specific implementations. For example, the technology applications 82e could include a parcel tracking program for delivery service applications, an equipment tracking program for emergency and utility service applications, or a local restaurant guide for consumers and commercial users alike. The backend applications 82 may comprise some, all, or other suitable programs without departing from the spirit and scope of the present invention. For example, the backend applications 82 may include security programs, databases 23 and web access for the entities 24 to access the backend applications 82, as described below.

The central office 14 preferably includes a network connection 86 that operates to connect the central office 14 to the external network 26 and allow entities 24 to interact with the backend applications 82 running on the computer system 80. In the preferred embodiment, the network connection 84 is one or more high speed Internet connections on at least one Internet backbone. The network connection 86 generally includes security software that prevents unauthorized access to the backend applications 82.

The central office 12 may comprise other suitable systems and applications without departing from the spirit and scope of the present invention. For example, the central office 12 may include a connection to a third party help line instead of having the operator 28 on site within the central office 14.

Throughout the description and claims of this specification the word “comprise” and variation of that word, such as “comprises” and “comprising”, are not intended to exclude other additives, components, integers or steps. While the invention has been particularly shown and described in the foregoing detailed description, it will be understood by those skilled in the art that various other changes in form and detail may be made without departing from the spirit and scope of the invention as set forth in the appended claims.

What is claimed is:

1. A tracking system comprising:
a plurality of tracking units, with at least one tracking unit comprising:
a display;
a locator operable to determine the position of the tracking unit;
a multimode communication system operable to use at least two communication networks to communicate with a central office; and
the central office operable to receive the position of the tracking unit and send navigation data to the tracking unit for displaying on the display.

2. The tracking system of claim 1, wherein the central office operates to manage the delivery and pickup of packages.

3. The tracking system of claim 1, wherein the central office operates to manage the deployment of emergency service personnel.

4. The tracking system of claim 1, wherein the central office operates to manage the deployment of utility service equipment and personnel.

5. The tracking system of claim 1, wherein the central office operates to provide navigation data to a traveler.

6. The tracking system of claim 1, wherein the central office operates to continuously send the tracking unit updated navigation data based on at least one of the following environmental effects: traffic, weather and construction.

7. The tracking system of claim 1, wherein:
a user can enter a query on the display of the tracking unit;
the query is communicated the central office;
a database at the central office is searched based on the query to find a query result; and
the query result is communicated to the tracking unit and displayed to the user.

8. The tracking system of claim 7, further comprising:
the user can select one of the query results;
the selected query result is communicated to the central office and the navigation data is determined from the current position of the tracking unit to the location related to the selected query result; and
the navigation data sent to the tracking unit for viewing on the display.

9. The tracking system of claim 1, wherein the central office operates to send destination navigation data to the tracking unit for viewing on the display.

10. The tracking system of claim 1, wherein the central office operates to send updated navigation data to the tracking unit for viewing on the display.

11. The tracking system of claim 10, wherein the updated navigation data is based on changes in traffic patterns.

12. The tracking system of claim 1, wherein the central office can be accessed through an Internet network connection.

13. The tracking system of claim 12, wherein the navigation data sent to individual tracking units is managed remotely through the Internet network connection.

14. The tracking system of claim 13, wherein a first set of tracking units are associated with a first entity and a second set of tracking units are associated with a second entity, wherein the first and second entities can simultaneously access the central office through the Internet network connection and manage the navigation data for the tracking units associated with each respective entity.

15. The tracking system of claim 1, wherein at least one tracking unit is a portable device.

16. The tracking system of claim 1, wherein at least one tracking unit is operable to be coupled to a vehicle.

17. The tracking system of claim 16, further comprising a cradle operable to be installed in a vehicle, wherein the cradle enables the tracking unit to be removably attached to the vehicle.

18. The tracking system of claim 16, wherein the tracking unit also operates to communicate vehicle information to the central office.

19. The tracking system of claim 1, wherein the locator utilizes a Global Positioning System receiver to determine the position of the tracking unit.

20. The tracking system of claim 1, wherein the locator utilizes a cellular triangulation receiver to determine the position of the tracking unit.

21. The tracking system of claim 1, wherein the multimode communication system includes a cellular communication system.

22. The tracking system of claim 1, wherein the multimode communication system includes a satellite communication system.

23. The tracking system of claim 1, wherein the multimode communication system includes a radio communication system.

24. The tracking system of claim 1, wherein the tracking unit is modular to enable functionality to be added to the tracking unit.

25. The tracking system of claim 1, wherein the tracking unit includes software that can be remotely updated by the central office.

26. The tracking system of claim 1, wherein the tracking unit can operate in an energy savings mode.

27. The tracking system of claim 1, wherein a user can select options on the display during setup to personalize a view on the display.

28. The tracking system of claim 1, wherein the tracking unit includes speakers operable to provide audible cues during operation of the tracking unit.

29. The tracking system of claim 28, wherein the tracking unit further comprises a microphone that enables the tracking unit to be controlled by voice commands.

30. The tracking system of claim 28, wherein the tracking unit further comprises a microphone that enables two way conversation.

31. The tracking system of claim 30, wherein a user interacting with the tracking unit can place a phone call to another person.

32. The tracking system of claim 1, wherein the tracking unit also includes a memory device operable to store local navigation information.
